(19) United States
(12) Patent Application Publication
(10) Pub. No.: US 2013/0132427 A1
(43) Pub. Date: May 23, 2013

(54) APPARATUS FOR SEARCHING FOR INFORMATION WITHIN SPACE OF INTEREST

(71) Applicants: Cheol-Woo Park, Seoul (KR); Soon-Sung Kwon, Anyang (KR); Hong-Hoi Kim, Daejeon (KR)

(72) Inventors: Cheol-Woo Park, Seoul (KR); Soon-Sung Kwon, Anyang (KR); Hong-Hoi Kim, Daejeon (KR)

(73) Assignee: HYUNDAI MOTOR COMPANY, Seoul (KR)

(21) Appl. No.: 13/618,330

(22) Filed: Sep. 14, 2012

Related U.S. Application Data
(63) Continuation-in-part of application No. 13/320,649, filed on Nov. 15, 2011.
(60) Provisional application No. 61/599,189, filed on Feb. 15, 2012.

(30) Foreign Application Priority Data
May 15, 2009 (KR) 10-2009-0042401

(51) Int. Cl. G06F 17/30

(52) U.S. Cl. CPC G06F 17/30864
USPC 707/769

(57) ABSTRACT

One aspect of the invention provides an apparatus for searching for position information. The apparatus includes: a search input unit for receiving a search request from a user, the search request specifying (i) one or more search terms and (ii) one or more space of interest (SOI) objects in which the search is to be conducted; a search processing unit for conducting a search for the one or more search terms within the one or more SOI objects specified in the search request and one or more sub-SOIs of the one or more specified SOI objects; a database; and a search output unit for outputting a result of the search by the search processing unit to the user.

### CROSS-REFERENCE TO RELATED APPLICATION

This application claims priority under 35 U.S.C. §119(e) to U.S. Provisional Patent Application Ser. No. 61/599,189, filed Feb. 15, 2012. This application is also a continuation-in-part under 35 U.S.C. §120 of U.S. patent application Ser. No. 13/320,649, filed Nov. 15, 2011, which is a national phase application under 35 U.S.C. §371 of International Application No. PCT/KR2010/003055, filed May 14, 2010, which claim priority to Korean Patent Application No. 10-2009-0042401, filed May 15, 2009. The entire content of each of the above-referenced patent applications is hereby is incorporated by reference herein.

### FIELD OF THE INVENTION

The present invention relates to an apparatus for searching for information within a space of interest (hereinafter referred to as “SOI”) and, more particularly, to an apparatus for searching for position information, which is capable of precisely searching for several pieces of information, etc. within an SOI by limiting the SOI. A space of interest (SOI) refers to a collection of data about a space of people's interest or use. An SOI is made up of point, line and/or plane and has a unique identifying data.

### BACKGROUND OF THE INVENTION

In general, technology for setting coordinates X/Y in a specific point included in map information and providing data matched with the set coordinates is used in a conventional apparatus for searching for position information. The specific point refers to a firm or shop name or a name which can become the subject of interest of a user. The set coordinates are connected to point of interest (hereinafter referred to as a “POI”) information, thus providing data desired by the user.

FIG. 1 is a diagram showing a conventional method of searching for position information. The conventional method is described in short with reference to FIG. 1.

For example, a user can search for a game machine store placed within an electronics store called “Y Electronics Mall.”. The user can enter a search word “Electronics Store Game Machine”. In this case, however, as shown in FIG. 1, the search results include not only a game machine store A within the electronics mall, but also a game machine store B outside the electronics mall.

This is because according to the conventional method, when position information is searched for, only the X/Y coordinates of a POI are displayed in a map and only a name or category similar to a keyword entered by a user is searched for. Accordingly, the conventional method is problematic in that the result of the search is not correct because all the stores, such as Y Electronics Shopping Center, which has a keyword similar to a game machine and which is adjacent to Y Electronics Mall, are outputted although the user sought to search for a store related to the game machine only within Y Electronics Mall. In other words, the conventional method is problematic in that a condition that “the store desired by the user is placed only within the electronics mall” is not satisfied.

### BRIEF SUMMARY OF THE INVENTION

One aspect of the invention provides an apparatus for searching for position information. The apparatus includes: a search input unit for receiving a search request from a user, the search request specifying (i) one or more search terms and (ii) one or more space of interest (SOI) objects in which the search is to be conducted; a search processing unit for conducting a search for the one or more search terms within the one or more SOI objects specified in the search request and one or more sub-SOIs of the one or more specified SOI objects; a database; and a search output unit for outputting a result of the search by the search processing unit to the user.

In one embodiment, the SOI has a relationship set up with other SOIs and content.

In another embodiment, the search input unit inputs a request for a position information search by providing objects or an SOI selection window to the user based on graphic information and making selection from among the objects or pieces of SOI information.

In another embodiment, the SOI database stores the SOI, a type of relationship structure for the SOI, and an object position data indicating a position of an object corresponding to the SOI.

In another embodiment, the search processing unit sets lower level SOIs of the SOI object as the subject of search with reference to the SOI database, performs a keyword search for the search word received from the search input unit, and then determines whether a result of the keyword search is included in the set subject of search.

In another embodiment, the search processing unit selects only results in which the result of the keyword search is included in the subject of search and transmits the results to the search output unit.

In another embodiment, the search output unit displays the result of the search from the search processing unit in a detailed information form or displays the result of the search from the search processing unit in a position information form on a map.

In another embodiment, the search input unit receives SOI information from the user and requests a search from the search processing unit.

In another embodiment, the search input unit further includes a search area selection unit configured to receive a selection of one or more SOIs for inclusion in a search area.

In another embodiment, the search input unit further includes a search word input unit configured to receive a search word to be searched for within the one or more SOIs.

Another aspect of the invention provides a method for searching for position information. The method includes: receiving a search request from a user, the search request specifying (i) one or more search terms and (ii) one or more space of interest (SOI) objects in which the search is to be conducted; conducting a search for the one or more search terms within the one or more SOI objects specified in the search request and one or more sub-SOIs of the one or more specified SOI objects; and returning a result of the search.

In one embodiment, the step of conducting a search including searching within content associated with one or more selected from the group consisting of: (i) the one or more SOI objects specified in the search request and (ii) one or more sub-SOIs of the one or more specified SOI objects.

Another aspect of the invention provides a computer program product including computer-usable medium having control logic stored therein for causing a computer to perform a method for searching for position information. The control logic includes: first computer readable program code means for causing the computer to receive a search request from a user, the search request specifying (i) one or more search terms and (ii) one or more space of interest (SOI) objects in which the search is to be conducted; second computer readable program code means for causing the computer to conduct a search for the one or more search terms within the one or more SOI objects specified in the search request and one or more sub-SOIs of the one or more specified SOI objects; and third computer readable program code means for causing the computer to return a result of the search.

Another aspect of the invention provides an apparatus for searching for position information. The apparatus includes: a search input unit for receiving a search request from a user, the search request specifying (i) one or more search terms and (ii) one or more space of interest (SOI) objects in which the search is to be conducted; a search processing unit for conducting a search for the one or more search terms within content associated one or more selected from the group consisting of: (i) the one or more SOI objects specified in the search request and (ii) one or more sub-SOIs of the one or more specified SOI objects; a database; and a search output unit for outputting a result of the search by the search processing unit to the user.

Another aspect of the invention provides a method for searching for position information. The method includes: receiving a search request from a user, the search request specifying (i) one or more search terms and (ii) one or more space of interest (SOI) objects in which the search is to be conducted; conducting a search for the one or more search terms within content associated with one or more selected from the group consisting of: (i) the one or more SOI objects specified in the search request and (ii) one or more sub-SOIs of the one or more specified SOI objects; and returning a result of the search.

Another aspect of the invention provides a computer program product including computer-usable medium having control logic stored therein for causing a computer to perform a method for searching for position information. The control logic includes: first computer readable program code means for causing the computer to receive a search request from a user, the search request specifying (i) one or more search terms and (ii) one or more space of interest (SOI) objects in which the search is to be conducted; second computer readable program code means for causing the computer to conduct a search for the one or more search terms within content associated with one or more selected from the group consisting of: (i) the one or more SOI objects specified in the search request and (ii) one or more sub-SOIs of the one or more specified SOI objects; and third computer readable program code means for causing the computer to return a result of the search.

### BRIEF DESCRIPTION OF THE DRAWINGS

FIG. 1 is a diagram showing a conventional method of searching for position information;

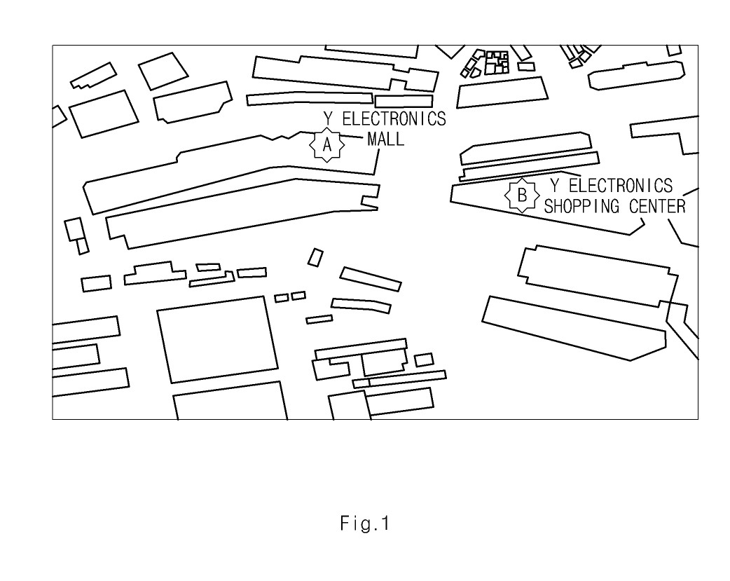

FIG. 2 is a diagram showing the common structure of an SOI object according to the present invention;

FIG. 3 is a block diagram of an apparatus for searching for position information within an SOI according to an embodiment of the present invention; and

FIG. 4 is a screen showing the final search result provided from a search output unit 320 to a user.

### DESCRIPTION OF EMBODIMENTS

Hereinafter, some embodiments of the present invention will be described in detail with reference to the accompanying drawings. It is to be noted that in assigning reference numerals to respective constituent elements in the drawings, the same reference numerals designate the same constituent elements throughout the drawings although the constituent elements are shown in different drawings. Furthermore, in describing the present invention, detailed descriptions of the known functions and constructions will be omitted if it is deemed to make the gist of the present invention unnecessarily vague.

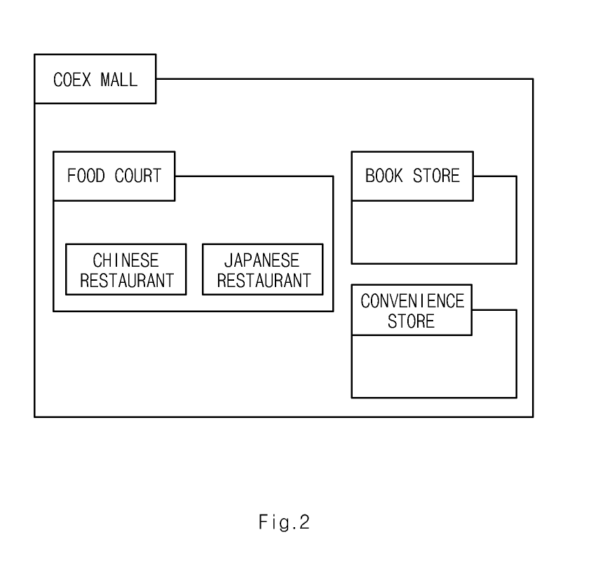

FIG. 2 is a diagram showing the common structure of a space object according to the present invention.

A food court, a book store, and a convenience store exist within a mall called “Coex Mall,” and a Chinese restaurant and a Japanese restaurant exist within the food court within the mall. A SOI object according to the present invention accurately represents and manages the layer of the space in the form of a vertical or horizontal relationship structure. Coex Mall is defined as a higher level SOI, and the food court, the book store, and the convenience store within Coex Mall (i.e., lower level SOIs of Coex Mall) exist in the form of a vertical relationship structure. Furthermore, the Chinese restaurant and the Japanese restaurant (i.e., the lowest level SOIs) exist within the food court, which is a lower level SOI of the higher level SOI, i.e. Coex Mall.

Although simply shown for convenience of description, only one SOI is defined in the form of a hierarchical organization relationship. Accordingly, in the present invention, pieces of information about lower level SOIs included in a specific space can be searched for by limiting a specific SOI itself or limiting the space including a plurality of SOIs.

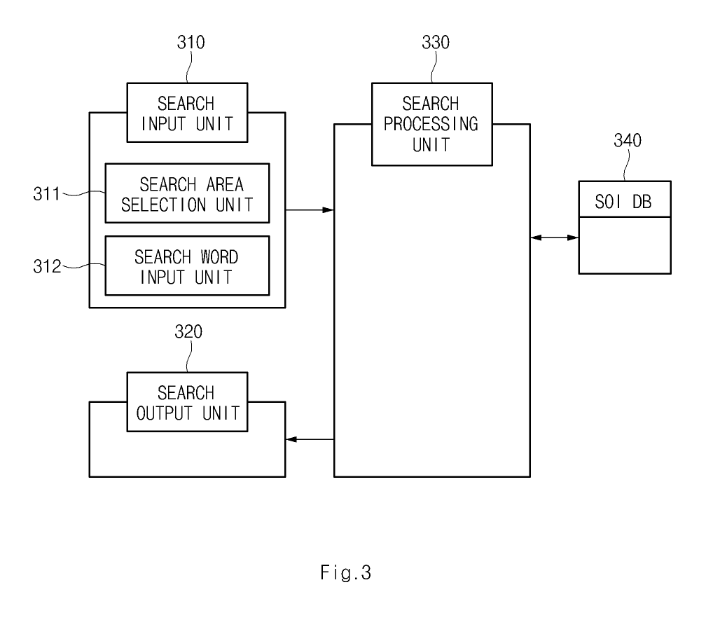

FIG. 3 is a block diagram of an apparatus for searching for position information within an SOI according to an embodiment of the present invention. The apparatus for searching for position information according to the present invention chiefly includes a search input unit 310, a search output unit 320, a search processing unit 330, and an SOI database 340.

The search input unit 310 includes an interface enabling a user to select a specific SOI object and to make a search. The search input unit 310 further includes a search area selection unit 311 and a search word input unit 312. The search area selection unit 311 enables a user to select a specific SOI object. As a detailed example, there is a method in which an SOI map displaying SOIs on a map is presented to a user and the user individually selects an SOI to be selected as a search range in the SOI map. In some embodiments, a function of selecting a specific space area in the SOI map can also be provided. Furthermore, the search word input unit 312 functions to receive a search word to be searched for within the SOI selected in the search area selection unit 311.

The search output unit 320 functions to display the result that the search processing unit 330 analyzes a search condition requested by the search input unit 310 and searches the SOI database 340 to a user. The search output unit 320 will be described in detail later.

The search processing unit 330 receives a specific SOI, corresponding to a search range, and a search word from the search input unit 310 and defines a range of the specific SOI on the basis of the specific SOI and the search word. As described with reference to FIG. 2, a higher level SOI and a lower level SOI basically have a vertical relationship. Pieces of information including the vertical relationship are stored in the SOI database 340.

When an SOI of a search range is received, the search processing unit 330 first sets lower level SOIs of the SOI as the subject of search while operating in conjunction with the SOI database 340.

Next, the search processing unit 330 performs a keyword search for a search word received from the search input unit 310 by using a common search engine and checks whether the result of the keyword search overlaps with the SOI of the subject of search and lower level SOIs of the SOI of the subject of search.

Next, the search processing unit 330 determines a suitable search result only within the overlapping range and transfers the suitable search result to the search output unit 320. The lower level SOIs can be recursively traversed and searched using various tree navigation techniques known to those of ordinary skill in the art.

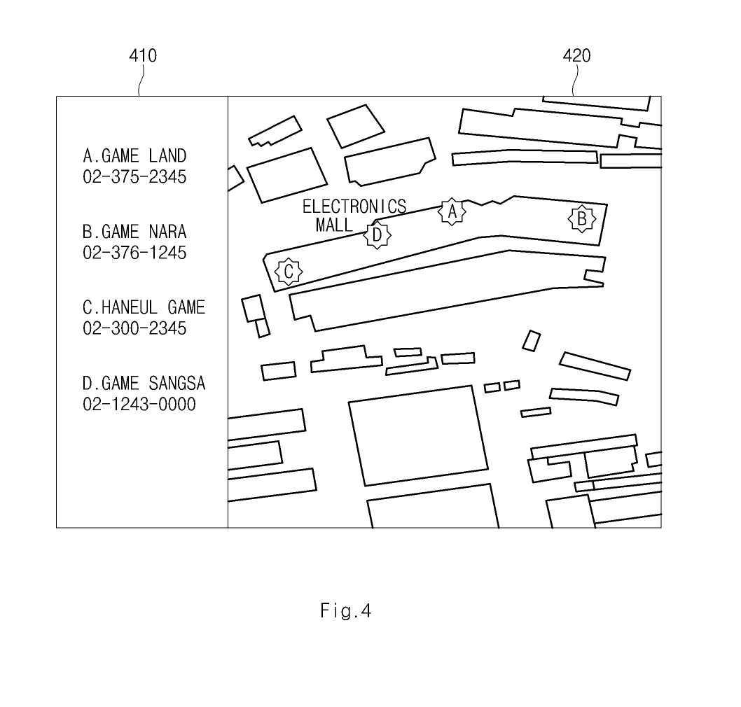

FIG. 4 is a screen showing the final search result provided from the search output unit 320 to a user.

For example, when a user selects an SOI object “electronics mall” through the search input unit 310 and enters a search keyword “game machine”, the result of search can be displayed as in FIG. 4.

The search result can include a detailed information display unit 410 and an SOI display map 420. The detailed information display unit 410 can display rough information and detailed information about enterprises that sell game machines within the electronics mall. In accordance with the present invention, the displayed enterprises have object characteristics as lower level SOIs. Accordingly, the displayed enterprises can be further selected, and additional search for the displayed enterprises can be performed.

Furthermore, game machine seller information as the search result is displayed in the SOI display map 420 of the map, and the user can select an SOI object of each game selling enterprise in order to receive additional information.

In this case, pieces of SOI information for lower level SOIs having a vertical relationship structure can be further provided. Here, if there is the lowest level SOI having a vertical relationship structure for the lower level SOIs, a search can be sequentially made down to the lowest level SOI.

In accordance with the present invention, the accuracy of a search can be increased because a user can make a search by limiting the range of the search for a desired SOI object.

Furthermore, the present invention can solve the limitation of a POI search in which a range of space desired by a user cannot be arbitrarily designated because the present invention is not based on a POI represented by only simple X/Y coordinate points and the present invention targets an SOI object including a space concept having a specific area form.

The apparatus and method for searching for position information can be implemented in the form of program commands which can be executed by computer means and can be stored in a computer-readable medium. The computer-readable medium can comprise program commands, data files, data structures, etc. solely or in combination. Meanwhile, the program commands recorded on the recording medium can be specially designed and configured for the present invention or can be known to a person having ordinary skill in the computer software.

The computer-readable recording medium can include, for example, magnetic media such as a hard disk, a floppy disk, and a magnetic tape, optical media such as CD-ROM and DVD, magneto-optical media such as a floptical disk, and hardware devices such as ROM, RAM, and flash memory which are specially configured to store and execute program commands. Meanwhile, the recording medium can be a transmission medium, such as an optical or metal line and a waveguide, including carriers for transmitting a signal to designate a program command or a data structure.

Furthermore, the program commands can include, for example, not only machine codes produced by a compiler, but also high-level language codes executable by a computer using an interpreter. The hardware device can be configured to be operated as one or more software modules in order to perform the operation of the present invention, and the inverse is the same.

Meanwhile, those having ordinary skill in the art to which the present invention pertains will appreciate that the present invention can be implemented in other detailed forms without changing the technical spirit or indispensable characteristics.

Accordingly, it should be understood that the above-described embodiments are only illustrative from all aspects and are not to be restrictive. The scope of the present invention is defined by the following claims rather than the detailed description, and the meanings and scope of the claims and all changes or modified forms induced from their equivalents should be interpreted to fall within the scope of the present invention.

What is claimed is:

1. An apparatus for searching for position information, comprising:
a search input unit for receiving a search request from a user, the search request specifying (i) one or more search terms and (ii) one or more space of interest (SOI) objects in which the search is to be conducted;
a search processing unit for conducting a search for the one or more search terms within the one or more SOI objects specified in the search request and one or more sub-SOIs of the one or more specified SOI objects;
a database; and
a search output unit for outputting a result of the search by the search processing unit to the user.

2. The apparatus according to claim 1, wherein the SOI has a relationship set up with other SOIs and content.

3. The apparatus according to claim 1, wherein the search input unit inputs a request for a position information search by providing objects or an SOI selection window to the user based on graphic information and making selection from among the objects or pieces of SOI information.

4. The apparatus according to claim 1, wherein the SOI database stores the SOI, a type of relationship structure for the SOI, and an object position data indicating a position of an object corresponding to the SOI.

5. The apparatus according to claim 1, wherein the search processing unit sets lower level SOIs of the SOI object as the subject of search with reference to the SOI database, performs a keyword search for the search word received from the search input unit, and then determines whether a result of the keyword search is included in the set subject of search.

6. The apparatus according to claim 5, wherein the search processing unit selects only results in which the result of the keyword search is included in the subject of search and transmits the results to the search output unit.

7. The apparatus according to claim 1, wherein the search output unit displays the result of the search from the search processing unit in a detailed information form or displays the result of the search from the search processing unit in a position information form on a map.

8. The apparatus according to claim 3, wherein the search input unit receives SOI information from the user and requests a search from the search processing unit.

9. The apparatus according to claim 1, wherein the search input unit further includes a search area selection unit configured to receive a selection of one or more SOIs for inclusion in a search area.

10. The apparatus according to claim 1, wherein the search input unit further includes a search word input unit configured to receive a search word to be searched for within the one or more SOIs.

11. A method for searching for position information, comprising:
receiving a search request from a user, the search request specifying (i) one or more search terms and (ii) one or more space of interest (SOI) objects in which the search is to be conducted;
conducting a search for the one or more search terms within the one or more SOI objects specified in the search request and one or more sub-SOIs of the one or more specified SOI objects; and
returning a result of the search.

12. The method of claim 11, wherein the step of conducting a search including searching within content associated with one or more selected from the group consisting of: (i) the one or more SOI objects specified in the search request and (ii) one or more sub-SOIs of the one or more specified SOI objects.

13. A computer program product comprising computer-usable medium having control logic stored therein for causing a computer to perform a method for searching for position information, the control logic comprising:
first computer readable program code means for causing the computer to receive a search request from a user, the search request specifying (i) one or more search terms and (ii) one or more space of interest (SOI) objects in which the search is to be conducted;
second computer readable program code means for causing the computer to conduct a search for the one or more search terms within the one or more SOI objects specified in the search request and one or more sub-SOIs of the one or more specified SOI objects; and
third computer readable program code means for causing the computer to return a result of the search.

14. An apparatus for searching for position information, comprising:
a search input unit for receiving a search request from a user, the search request specifying (i) one or more search terms and (ii) one or more space of interest (SOI) objects in which the search is to be conducted;
a search processing unit for conducting a search for the one or more search terms within content associated one or more selected from the group consisting of: (i) the one or more SOI objects specified in the search request and (ii) one or more sub-SOIs of the one or more specified SOI objects;
a database; and
a search output unit for outputting a result of the search by the search processing unit to the user.

15. A method for searching for position information, comprising:
receiving a search request from a user, the search request specifying (i) one or more search terms and (ii) one or more space of interest (SOI) objects in which the search is to be conducted;
conducting a search for the one or more search terms within content associated with one or more selected from the group consisting of: (i) the one or more SOI objects specified in the search request and (ii) one or more sub-SOIs of the one or more specified SOI objects; and
returning a result of the search.

16. A computer program product comprising computer-usable medium having control logic stored therein for causing a computer to perform a method for searching for position information, the control logic comprising:
first computer readable program code means for causing the computer to receive a search request from a user, the search request specifying (i) one or more search terms and (ii) one or more space of interest (SOI) objects in which the search is to be conducted;
second computer readable program code means for causing the computer to conduct a search for the one or more search terms within content associated with one or more selected from the group consisting of: (i) the one or more SOI objects specified in the search request and (ii) one or more sub-SOIs of the one or more specified SOI objects; and
third computer readable program code means for causing the computer to return a result of the search.
